(19) United States
(12) Patent Application Publication
(10) Pub. No.: US 2026/0154141 A1
(43) Pub. Date: Jun. 4, 2026

(54) Application Programming Interface Mirroring with Selective Request Handling

(71) Applicant: Capital One Services, LLC, McLean, VA (US)

(72) Inventor: Karthik Nagesh, Brambleton, VA (US)

(21) Appl. No.: 19/385,404

(22) Filed: Nov. 11, 2025

Related U.S. Application Data
(60) Provisional application No. 63/727,829, filed on Dec. 4, 2024.

(51) Int. Cl. G06F 9/54

(52) U.S. Cl. CPC G06F 9/547

(57) ABSTRACT

Systems, methods, and apparatuses are described for automatically generating mock Application Programming Interface (API) endpoints corresponding to a plurality of APIs provided by a third-party endpoint, selectively servicing API requests using internal data or routing those requests to a third-party endpoint, and collecting data to support such an internal model of a third-party API endpoint. A computing device may use a third-party API specification to generate an internal model of a third-party API and may service the API using, for example, internal data. In turn, requests received by an internal endpoint may be handled internally or routed to the third-party API endpoint providing the third-party API based on a variety of considerations. The computing device may collect and prepare data to support the internal model using internal data and/or services.

### FIELD OF USE

Aspects of the disclosure relate generally to Application Programming Interfaces (APIs). More particularly, aspects described herein describe a process for automatically generating a mock of an API provided by a third-party API endpoint and selectively routing API traffic to be either handled internally or by the third-party API endpoint.

### BACKGROUND

Codebases may rely on a variety of third-party APIs to function. For example, a user authentication function of a codebase might use an API provided by a third-party API provider to receive a validation of a token. As another example, during a registration process for a user in a high-security setting, a codebase may use API calls to a third-party API endpoint to transmit physical credentials (e.g., a driver's license) submitted by a user and receive an indication of whether the physical credentials are valid. Such API calls might be formatted and otherwise implemented using a specification, such as the Open API specification, meaning that different API calls might comprise different fields/structures but might have similarities (e.g., all APIs might be specified by an API specification provided by a local and/or third-party endpoint). In practice, the same codebase might rely on dozens (if not hundreds) of API calls, with some API calls made locally (e.g., to other processes executing on the same/nearby computing devices, such as within a corporate network) and some made to third-parties (e.g., to a remote server and over the Internet).

During development of a codebase, providing API requests (also known as API calls) to a third-party API endpoint can present a variety of logistical and security concerns. For example, development code can transmit poorly-formatted API requests that can unduly burden third-party API providers and/or might incur unexpected costs. After all, if a third-party API provider charges based on processing time, then a poorly-formatted API request from a development codebase could incur significant costs. Moreover, if such API calls cause queries to databases, malformed API calls could result in malformed queries that could result in data harm and/or loss. As another example, if development code transmitted poorly-formatted API requests, those calls could in some instances introduce security vulnerabilities (e.g., by transmitting confidential information in an unencrypted manner and/or in the wrong field).

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to automatically mirroring, provisioning, and managing an internal mock API that corresponds to a third-party API provided by a third-party API endpoint. A third-party endpoint may provide a variety of different APIs (e.g., validation APIs, data lookup APIs) that may be detailed by a third-party API specification. Processes described herein may retrieve that specification and generate an internal mock API that is configured to receive the same or similar request fields and provide the same or similar response fields. With that said, one of the many advantages of the present disclosure is that the servicing of a given API may involve different processes (e.g., use different data in response fields) than those performed by the third-party API endpoint. For example, the internal API may be configured to retrieve internal data that is not available to the third-party API endpoint, which may in some circumstances provide different and/or superior results as compared to the third-party API endpoint. Once generated, the internal API may be used to service requests received from external sources, such as development and/or production codebases. For example, upon receipt of an API request, an internal endpoint providing the internal mock API may process fields in the request, generate a response with one or more response fields and using internal data from a database unavailable to the third-party API endpoint, and send the response back to the transmitter of the API request.

More particularly, aspects described herein relate to a computing device configured to automatically generate and internal mock APIs corresponding to a plurality of APIs provided by a third-party API endpoint. The computing device may retrieve a third-party API specification that indicates supported request fields and supported response fields for each of a plurality of APIs provided by the third-party API endpoint. In this circumstance, the third-party API specification may indicate, for a first API of the plurality of APIs, formats of one or more first request fields and/or formats of one or more first response fields. The computing device may generate a mock first API corresponding to the first API based on the formats of the one or more first request fields and the formats of the one or more first response fields. That mock first API may be provided by an internal endpoint and is configured to service API requests corresponding to the first API using internal data. The computing device may then receive, from a second computing device, a first API request, to the mock first API, that comprises at least one field of the one or more first request fields corresponding to the first API. The computing device may generate, via the internal endpoint, using the internal data, and based on the first API request, a first API response that comprises at least one of the one or more first response fields, wherein the at least one field of the one or more first response fields comprises at least a portion of the internal data. The computing device may then transmit, via the internal endpoint and to the second computing device, the first API response. For instance, if the internal data corresponds to an authentication service, then the first API response may comprise an authentication result.

The mock API provided by the internal endpoint need not provide the same or similar data as that provided, via the third-party API, from the third-party API endpoint. For instance, the first API response may comprise a field, of the one or more response fields, that comprises a default value, randomized value, or the like. Such an approach might be taken where, for example, the internal endpoint is used for testing. Similarly, the API response provided via the internal API and from the internal endpoint need not comprise all of the same fields as might be received by the third-party API and from the third-party API endpoint. For example, the API response may comprise less than al of the fields of the one or more first response fields.

Generating the mock API may comprise generating an internal API specification. For example, the computing device may generate the mock first API by generating an internal API specification that indicates, for the mock first API, the at least one field of the one or more first response fields. In this way, the internal endpoint may provide, like the third-party endpoint, a list of APIs available via the internal endpoint.

The mock API may be periodically updated based on changes to the third-party API to which it corresponds. For example, the computing device may identify a change in the third-party API specification, determine that the change impacts at least one field of the formats of the one or more first request fields, and update, based on the change, the mock first API.

Aspects described herein also relate to selectively testing and routing API requests. The processes described above may result in a circumstance where there are two options for servicing a given API request: internal processes provided by an internal endpoint and corresponding to the internal mock API, and third-party processes provided by the third-party API endpoint and corresponding to the third-party API. In turn, aspects described herein relate to routing API requests to either of those endpoints. For example, at first, API requests received from a codebase might be serviced by the internal endpoint. That said, certain conditions (e.g., the shifting of a codebase from a development to a production state, the satisfaction of various code tests on the codebase, the availability of a third-party endpoint, the perceived difficulty of servicing the API request) might begin to route API requests to the third-party API endpoint. One of the many advantages of this approach is that codebases can transmit API calls to a single endpoint (that is, the internal endpoint, a separate endpoint, or similar process), and the API call might be selectively processed internally or routed externally without requiring changes in the codebase. For instance, the same API call might be transmitted to the same server, which might then decide whether to process the API call internally or forward the API call out to an appropriate third-party API endpoint. In turn, risks associated with switching the API uses of code are lessened somewhat. For instance, if a third-party API endpoint becomes unavailable (due to, for instance, temporary downtime), developers need not manually change all API calls in a codebase to direct them to an internal endpoint, but those calls can be automatically routed (or not automatically routed) as desired.

More particularly, aspects described herein relate to a computing device configured to selectively service API calls using internal data or routing to a third-party API endpoint. The computing device may receive, from a second computing device, a first API request to a mock first API provided by an internal endpoint. That mock first API may correspond to a first API provided by the third-party API endpoint and may be configured to service at least a portion of calls using internal data and route at least a portion of calls to the first API. Moreover, the mock first API may be configured to service API requests corresponding to the first API using internal data and/or services. The computing device may determine whether to handle the first API call using internal data based on criteria specifying whether to handle first API calls via the internal endpoint or the third-party API endpoint by generating, based on the first API request, a first API response that comprises one or more first response fields specified by a third-party API specification for the first API and transmitting, to the second computing device and in response to the first API request, the first API response. The computing device may receive, from the second computing device, a second API request and, based on determining to not handle the first API call using the internal data, route the second API request to a third-party API endpoint. The computing device may then receive, from the third-party API endpoint, a second API response, generate a response based on the second API response received from the third-party API endpoint, and send, to the second computing device, the response generated based on the second API response.

Different API requests handled internally may be handled via different processes. For example, the computing device may receive, from the second computing device, a third API request and then, based on the criteria, process the third API request using the internal endpoint by generating, using the internal endpoint and based on the third API request, a third API response using a different process compared to the generation of the first API response and transmitting, to the second computing device and in response to the first API request, the first API response.

API requests may be processed internally (e.g., via an internal endpoint, once received via the internal mock API) or sent to a third-party endpoint based on a variety of factors. As part of determining whether to handle the first API call using internal data, the computing device may determine whether to handle the first API request via the internal endpoint or the third-party API endpoint based on whether code executing on the second computing device is in a development status. For example, if the code is in a development status, internal resources may be used. As another example, the computing device may receive a result of one or more code tests and, based on that result, determine whether to handle an API call internally based on the result. The computing device may, as part of determining whether to process an API request locally or forward it to a third-party endpoint, determine whether the internal data can be used to generate a response to an API request. For instance, if the internal data is unlikely to have an answer to the API request (e.g., based on the fields in the request), then the API request might be forwarded to the third-party API endpoint. The computing device may, as part of determining whether to process an API request locally or forward it to a third-party endpoint, determine whether a third-party API specification has changed. For example, if an internal mock API is different from a third-party API due to a recent change to the third-party API, then API requests might be routed to the third-party API until the internal mock API is updated.

When handled internally, API requests may be processed using internal data and/or services. For example, the computing device may return a default value for a field, use internal data to wholly or partially populate a field, and/or may use random data for a field. In turn, the processing and response provided by an internal endpoint may be based on very different internal processes as compared to the processes used by a third-party endpoint that provides a third-party API.

Aspects described herein also relate to the process by which data may be collected and prepared for use in servicing responses provided by an internal API generated based on a third-party API provided by a third-party API endpoint. When generated, the internal API endpoint may be broadly capable of receiving requests with certain fields (e.g., one or more request fields formatted in accordance with one or more request field formats) and outputting responses with certain fields (e.g., one or more response fields formatted in accordance with one or more response field formats). That said, to actually provide genuine responses (e.g., to actually perform authentication, object identification, or the like), an internal endpoint servicing the internal API must have access to appropriate data. For instance, to perform authentication, the internal endpoint may need access to username and hashed password combinations, whereas, to perform object identification, the internal endpoint may need access to a trained machine learning model (e.g., weights of the model) to perform the requisite object identification. As will be detailed further below, this provides a number of advantages: it means that the internal API (even if used temporarily during code development) can provide realistic responses, and in some circumstances it means that the internal API can perform better than the original third-party API from which it was derived.

More particularly, aspects described herein relate to a computing device configured to automatically provision data to support one or more internal mock APIs corresponding to one or more of a plurality of APIs provided by a third-party API endpoint. The computing device may receive an indication of a selection of a first API of the plurality of APIs provided by the third-party API endpoint and may receive a selection of one or more sets of data, from one or more databases, to be used in responding to calls corresponding to the selected first API. The computing device may then generate a mock first API corresponding to the selected first API. That mock first API may be provided by an internal endpoint and may be generated based on formats of first request fields and formats of first response fields specified by a third-party API specification for the first API. Moreover, the mock first API may be configured to service API requests corresponding to the first API using the one or more sets of data. The computing device may then store an association between at least one field of the first request fields and the first response fields and/or at least one data element of the one or more sets of data from the one or more databases. The computing device may then receive a first API request to the mock first API provided by the internal endpoint and generate, based on the association, based on the first API request, and using the internal endpoint, a first API response. That first API response may comprise, in at least one response field of the first response fields, at least a portion of the at least one data element. The computing device may then send the first API response.

Users may specify which data element(s) to be used by a mock API in a variety of ways. For example, a user might specify some portion of data (e.g., a column, a row, a table, a list) for use in identifying content for a particular field in an API response. In this manner, a user might point the mock API to real-world data that can be queried to identify content for insertion into a mock API response. The user might additionally and/or alternatively specify that a field is to be filled programmatically (e.g., using an algorithm such as a random number generator, a hash algorithm, or even a more sophisticated algorithm configured to generate realistic-looking data for a particular field). The user might also specify that a field is to be left with a default value and/or empty.

The data identified for use by a mock API might be cached and maintained separate from real-world data. For example, the computing device may be configured to cache at least a portion of the one or more sets of data and use that cached data as part of generating API responses. Such caching has a number of benefits in terms of speed and security, particularly if the API requests are received from code in development. Along those lines, the mock API (and, as applicable, the cached data for the mock API) may be used based on whether code executing on a second computing device is in a development status.

The data used by a mock API might be updated based on changes to a real API to which the mock API corresponds. For example, the computing device may receive an indication of a change to the third-party API specification and, in response, modify the mock first API to service API requests corresponding to the first API using one or more second sets of data different from the one or more sets of data.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an illustrative system including a user device, an internal endpoint, a third-party API endpoint, and internal databases.

FIG. 3 is an illustrative flow chart comprising steps for automatically generating internal mock APIs corresponding to a plurality of APIs provided by a third-party API endpoint.

FIG. 4 is an illustrative flow chart comprising steps for selectively servicing API calls using internal data or routing those requests to a third-party API endpoint.

FIG. 5 is an illustrative flow chart comprising steps for automatically provisioning data to support one or more internal mock APIs corresponding to one or more of a plurality of APIs provided by a third-party API endpoint.

FIG. 6 shows an example of a third-party API specification.

FIG. 7 shows associations between request fields, internal databases, and response fields.

FIG. 8 shows a comparison of an example of third-party API request fields and mock API request fields.

FIG. 9 is an illustrative flow chart comprising steps for implementing an internal mock API in view of code tests.

FIG. 10 depicts how code might be configured to selectively use either an internal mock API or a third-party API.

FIG. 11 compares how a phone number validation API might be performed both before and after the benefits of the present invention.

FIG. 12 depicts an example of how an internal mock API might be serviced using a series of processing procedures defined by a user.

FIG. 13 depicts a system involving a user, a vendor environment, and a developer environment with respect to a third-party endpoint and an internal endpoint.

FIG. 14 is an illustrative flow chart comprising steps for receiving user instructions for creating internal mock APIs.

FIG. 15 is an illustrative user interface showing user selection of data for use in API responses from an internal mock API.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, a wide variety of API requests may be transmitted by codebases (e.g., programs, scripts, and the like). Those API requests may be received by API endpoints providing various APIs, which ultimately cause processes provided internally or externally (e.g., via third parties) to provide responses via those API endpoints. For instance, an API request for a search function may result, after processing, in an API response with search results. As another example, an API request for an object identification API may comprise an image, and the API response generated after processing may comprise one or more indications of objects in that image. As yet another example, an API request for a text-to-speech algorithm may comprise textual content, and the API response after processing may comprise an audio file. A given codebase may rely on tens, if not hundreds or thousands, of different APIs (both local and third-party), meaning that managing those APIs (and, for example, making sure the codebase calls them properly and handles their responses properly) can be difficult.

Aspects described herein may remedy those and many other problems by generating an internal model of a third-party API endpoint. A third-party API specification provided by a third-party API endpoint may be used to generate an internal API (a mock API) that is configured to receive the same or similar request fields and provide the same or similar response fields. After the request has been processed, an internal API response may be generated, and that internal API response may contain dummy/random data, programmatically generated API data, and/or may use internal data (e.g., data from a database unavailable to the third-party endpoint). The result is that an internal API serviced by an internal endpoint may be automatically generated and maintained in a manner that provides similar (and, in some cases, better) performance as compared to the third-party API itself. In fact, in some circumstances, the internal API serviced by an internal endpoint may ultimately perform better due to speed (e.g., by virtue of being more local to the codebase) and because it has access to internal data, potentially not available to the third-party endpoint, that is more robust or better than data available to the third-party endpoint.

Aspects described herein may also remedy those issues by selectively routing API requests to the internal mock API (for processing by an internal endpoint) and/or a third-party API (for processing via a third-party endpoint). There may be circumstances when API requests should be routed to the internal endpoint via an internal mock API, such as when the third-party API endpoint is unavailable, when the internal endpoint performs better, when the codebase from which the request is received is in a development state and/or has yet to satisfy certain code tests, or the like. That said, even when an internal mock API is available, there may be circumstances when routing the API requests to the third-party API endpoint may still be valuable: for example, when the codebase is in a production state, when the internal API endpoint only provides mock data, or the like. Aspects described herein describe a process whereby a process (e.g., a routing process) may receive all API requests and route them, based on such considerations, to an internal API endpoint and/or a third-party API endpoint.

Aspects described herein may also remedy those issues by collecting and/or processing data in a manner that enables an internal API endpoint (e.g., one generated using the process described above) to use internal data for providing API responses. An internal mock API may be generated based on a third-party API specification indicating (for instance) API request and response fields, but that does not necessarily mean that, standing alone, the internal API is configured to appropriately respond to API requests. To enable an API to do so, aspects described herein relate to collecting data from one or more databases based on request and/or response fields of an API such that the internal API can provide appropriate responses to API requests. For example, if the internal API is an authentication API, aspects describe herein may collect authentication information (e.g., username information, password information) to enable authentication using that authentication information.

Aspects described herein may improve the functionality of computers by improving the ability via which API requests are received, responded to, and otherwise managed. The concept of an API request itself is fundamentally rooted in computers, and the idea that different codebases (e.g., on various computing devices) might transmit API requests and receive API responses is also fundamentally rooted in computers. Moreover, aspects described herein are particularly focused on issues inherent to computers: for example, enabling local (and not remote) processing of computing transmissions, using computer data to generate processes that are similar to remote processes that might not be wholly available for control, using internal processes (rather than third-party processes) to improve in computing security and response speed, and the like.

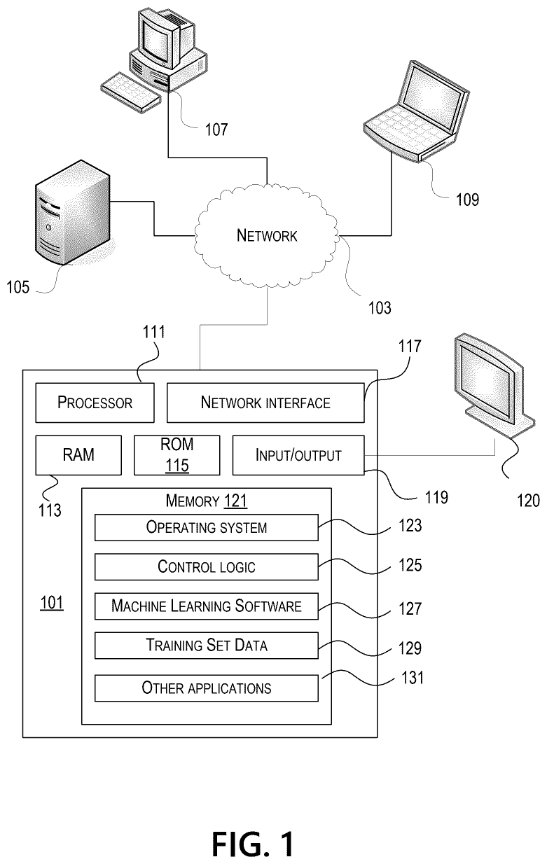

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

FIG. 1 also shows that the computing device 101 may comprise a Hardware Security Module (HSM) 132 and/or a Quantum Random Number Generator (QRNG) 133. The HSM 132 may comprise any computing module (e.g., one or more computer chips, attached cards, or the like) which may be capable of managing secrets, performing encryption and/or decryption, and/or otherwise performing security-and/or authentication-related functions. The HSM 132 may comprise, for instance, one or more secure cryptoprocessor chips which are capable of performing cryptographic operations. The QRNG 133 may comprise any computing module (e.g., one or more computer chips, attached cards, or the like) capable of generating a random number. Such a random number might be generated using quantum methods which permit the random number to have a high degree of entropy.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

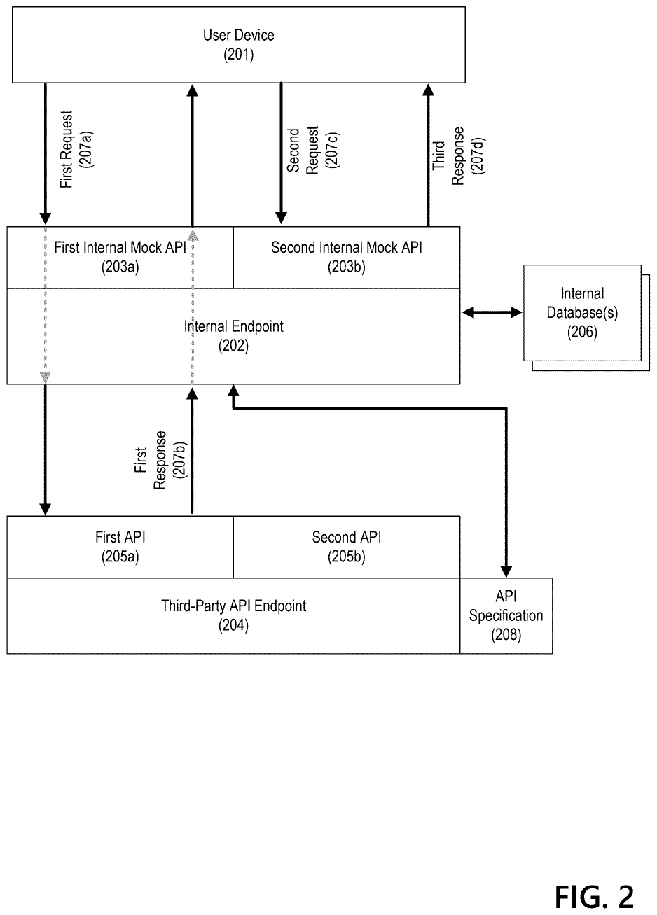

FIG. 2 depicts an illustrative system including a user device 201, an internal endpoint 202, a third-party API endpoint 204, and one or more internal databases 206. Any or all of the devices depicted in FIG. 2 may be a computing device, such as that described with respect to FIG. 1.

The user device 201 may comprise some computing device, such as a server, personal computer, or the like, that may execute code. For instance, an organization may develop a codebase (e.g., a user log-in script, a social networking platform) that may execute on the user device 201 and provide one or more functions to one or more users of the user device 201 or any other devices. In some circumstances, the user device 201 may be used as a development and/or production environment for code. For instance, the user device 201 may be used as part of a development environment that allows developers to experiment with code that provides API requests to the internal endpoint 202, which may then selectively either handle the API requests internally (particularly where the code is still new and/or untested) and/or route those API requests to the third-party API endpoint (e.g., if the development code is secure enough, passes code tests, or the like).

The internal endpoint 202 may be configured to perform a wide variety of API-handling tasks. The internal endpoint 202 may be configured to generate mock APIs. For instance, the internal endpoint 202 may be configured to retrieve API specification 208 provided by the third-party API endpoint 204 and generate, based on fields indicated by the API specification 208, an internal mock API configured to receive data using one or more request fields indicated by the API specification 208 and provide responses via one or more response fields indicated by the API specification 208. The internal endpoint 202 may be configured to receive and transmit API requests/responses via mock APIs. For example, the internal endpoint 202 may receive an API request via an internal mock API and, based on determining to handle the API request internally, may use internal data and/or services (e.g., the internal databases 206) to process data in request fields of the API request, generate an API response, and provide the API response back in a manner compliant with the internal mock API. The internal endpoint 202 may additionally and/or alternatively be configured to receive an API request, forward that API request to the third-party API endpoint 204 (and, as appropriate, to one of the APIs provided by the third-party API endpoint 204), receive a response from the third-party API endpoint 204, then send that response back to the provider of the API request.

To provide an example of how an internal mock API might be generated, the internal endpoint 202 may retrieve, from the third-party API endpoint 204, the API specification 208. That API specification 208 may detail various APIs provided by the third-party API endpoint 204, including the format(s) of request fields and/or response fields for each of the APIs. The internal mock API may then, for one or more of the APIs indicated by the API specification 208, generate a corresponding internal mock API. For instance, as depicted in FIG. 2, the internal endpoint 202 may maintain a first internal mock API 203a corresponding to the first API 205a provided by the third-party API endpoint 204 and may maintain a second internal mock API 203b corresponding to the second API 205b provided by the third-party API endpoint 204.

The one or more internal databases 206 may be accessible to the internal endpoint 202 to service internally-handled API requests. If an API request is received by the internal endpoint 202, and if the internal endpoint 202 decides to handle the API request internally (e.g., based on various criteria such as whether the code providing the API request is in a development status, whether the third-party API endpoint 204 is available, and the like), then the internal endpoint 202 may use data from the one or more internal databases 206 to determine a response to the API request. For example, if the API request comprises a username and password in request fields, then those fields might be used as part of a query to the one or more internal databases 206 to determine whether the username and/or password are valid.

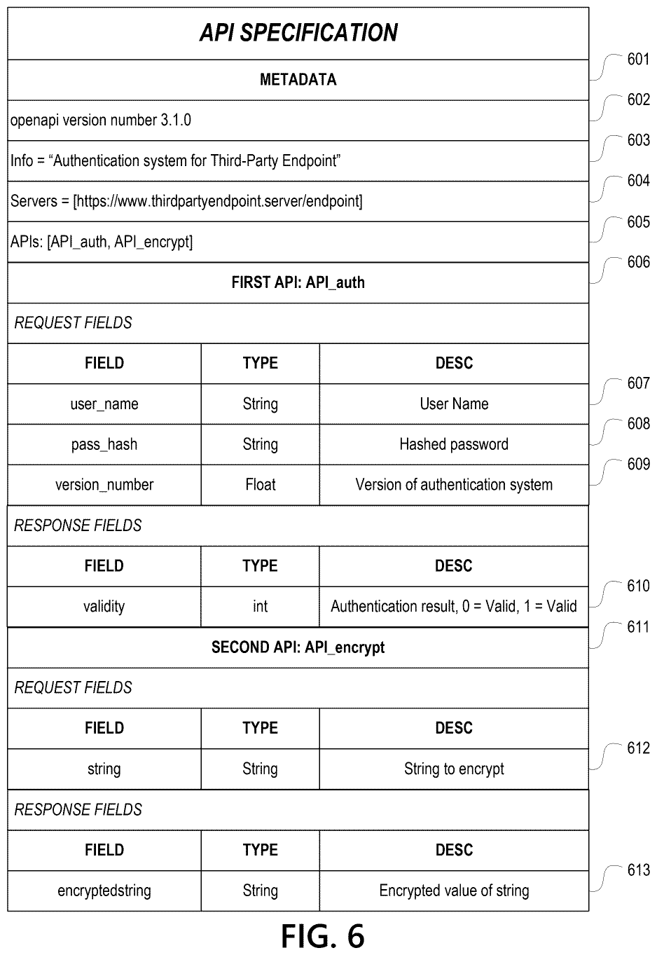

The third-party API endpoint 204 may be configured to provide various APIs, such as a first API 205a and a second API 205b, receive API requests via those APIs, and provide API responses via those APIs. As suggested by the nomenclature, the third-party API endpoint may be managed by a different organization as compared to the internal endpoint 202, meaning that the exact processes used by the third-party API endpoint (e.g., any internal data, services, and/or processes used to service API requests and generate API responses) might not be under the control of the organization that manages the internal endpoint 202. That said, details regarding the APIs themselves, including the fields for API requests/responses (including the format of those fields) may be detailed in the API specification 208 provided by the third-party API endpoint 204. An example of the API specification 208 is detailed with respect to FIG. 6.

To provide an example of how the devices in FIG. 2 might operate, the user device 201 may send a first API request 207a to a first internal mock API 203a provided by the internal endpoint 202. Based on a variety of criteria (e.g., properties of the request, such as whether the request can be serviced using data in the one or more internal databases 206), the request may be forwarded to the appropriate API provided by the third-party API endpoint 204 (depicted in FIG. 2 as the first API 205a, from which the first internal mock API 203a was generated). Then, a first API response 207b may be received from the third-party API endpoint (and in accordance with the first API 205a) and transmitted back to the user device 201. This process thereby routes an API request to the third-party API endpoint 204 and back to the user device 201. That said, API requests may be handled internally as well. For example, the user device 201 is shown in FIG. 2 as sending a second API request 207c to the internal endpoint 202 via the second internal mock API 203b. Based on the same or similar criteria, the internal endpoint 202 might instead internally handle the API request using, for example, data provided in the one or more internal databases 206. An API response may then be generated and transmitted back to the user device 201 without involvement of the third-party API endpoint 204.

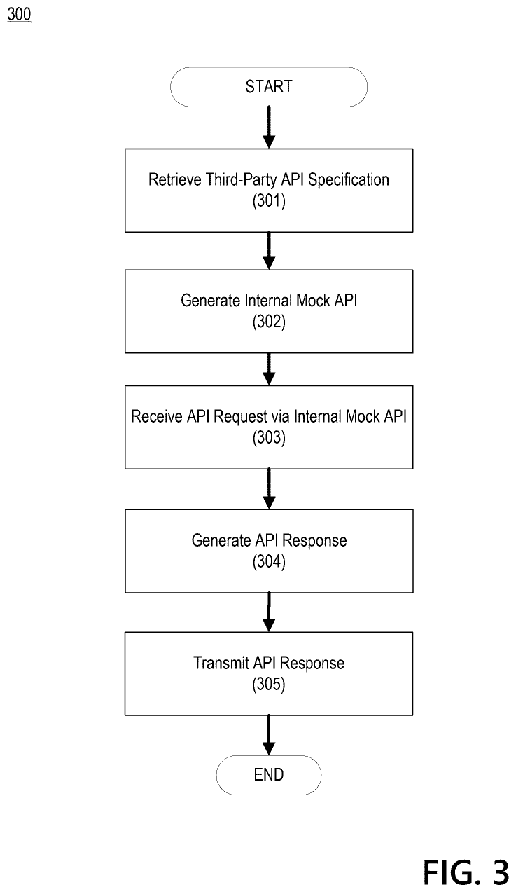

FIG. 3 depicts a method 300 comprising steps for automatically generating internal mock APIs corresponding to a plurality of APIs provided by a third-party API endpoint which may be performed by a computing device, such as any one of the devices described with respect to FIG. 1 and/or FIG. 2. The steps shown in FIG. 3 are illustrative, and may be re-arranged, omitted, and/or modified as desired. A computing device may comprise one or more processors and memory storing instructions that, when executed by the one or more processors, cause the performance of one or more of the steps depicted in FIG. 3. One or more non-transitory computer-readable media may store instructions that, when executed, cause the performance of one or more of the steps depicted in FIG. 3.

In step 301, a computing device may retrieve a third-party API specification. The third-party API specification may be the same or similar as the API specification 208 of FIG. 2. That third-party API specification may indicate, for each of a variety of APIs provided by a third-party API endpoint such as the third-party API endpoint 204, field(s) and other properties of the API. For example, the computing device may retrieve a third-party API specification that indicates supported request fields and supported response fields for each of a plurality of APIs provided by the third-party API endpoint. That API specification may indicate, for a first API of the plurality of APIs, formats of one or more first request fields and/or formats of one or more first response fields. An example of such a third-party API specification is detailed with respect to FIG. 6.

The third-party API specification may detail a large variety of information about APIs provided by the third-party API endpoint, such as formats of API request and/or API response fields. The formats of the one or more first request fields may indicate, for each of a plurality of request fields, a field name and a data type. For instance, a username field might be specified and require string input, whereas a currency amount field might accept float and/or integer values. As will be detailed below, this information can be directly used to generate an internal mock API that accepts similar request fields and outputs similar response fields. Other data from the third-party API specification might be useful as well: for example, some third-party API specifications might comprise metadata such as version numbers (e.g., OpenAPI version numbers), server indicators, formatting requirements, or the like, all of which may be usable to generate a similar internal mock API.

In step 302, the computing device may generate an internal mock API based on the third-party API specification. As suggested above, this may comprise mocking some or all of the request and/or response fields indicated in the third-party API specification. For example, the computing device may generate a mock first API corresponding to the first API based on the formats of the one or more first request fields and the formats of the one or more first response fields. The internal mock API may be configured such that it can receive API requests and provide API responses in a similar manner to the third-party API to which it mocks, albeit using internal data and/or services. For example, the mock first API may be provided by an internal endpoint and is configured to service API requests corresponding to the first API using internal data.

As part of generating the internal mock API, the computing device may act substantially similar to the third-party API endpoint. In this manner, even if merely for the purposes of testing, the computing device may provide substantially API responses as if the API requests were being handled by a third-party endpoint. This may include publishing metadata, such as a separate internal API specification. For example, the computing device may generate an internal API specification that indicates, for the mock first API, the at least one field of the one or more first response fields. Such an internal API specification might be particularly useful where, for example, the internal mock API uses some (but not all) of the fields used by the third-party API which it is based on.

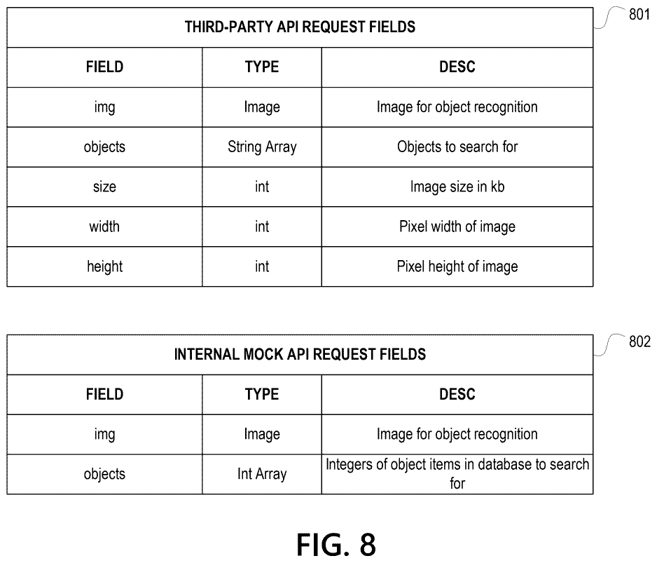

The internal mock API may be periodically updated or modified based on activity by the third-party API endpoint. In this manner, the internal mock API may continually comprise an accurate version of the third-party API which it is based on. For instance, the computing device may identify a change in the third-party API specification, determine that the change impacts at least one field of the formats of the one or more first request fields, and update, based on the change, the mock first API. With that said, such updates need not mean that the two APIs are identical. Indeed, as discussed above (and as detailed by example with respect to FIG. 8), the two APIs may be similar but may accept/respond with very different sets of fields under certain circumstances.

In step 303, the computing device may receive an API request via the internal mock API. Where the computing device is an internal endpoint such as the internal endpoint 202 of FIG. 2, this may comprise receiving data comprising an internal API request formatted in compliance with a mock API provided by the internal endpoint 202, such as the first internal mock API 203a and/or the second internal mock API 203b. That format may comprise one or more request fields comprising data. For example, the computing device may receive, from a second computing device, a first API request, to the mock first API, that comprises at least one field of the one or more first request fields corresponding to the first API.

In step 304, the computing device may generate an API response. Generating the API response may comprise using internal data and/or services (e.g., from the one or more internal databases 206) to determine a response to an API response and based on data in the API request (e.g., data in request fields of the API request). For example, the computing device may generate, via the internal endpoint, using the internal data, and based on the first API request, a first API response that comprises at least one of the one or more first response fields. In such a circumstance, the at least one field of the one or more first response fields may comprise at least a portion of the internal data.

The API response need not comprise genuine data. In many cases, such as where an internal mock API is used for testing purposes and not production purposes, it may be advantageous to not use real data and instead use dummy data for testing purposes. Moreover, in some cases, third party API responses may contain data not necessary for the codebase (e.g., some additional data field comprising metadata that is not used by a particular codebase), meaning that the content of a particular response field might not be particularly important. In turn, a second field of the one or more response fields may comprise a default value and/or a randomized value. In such a circumstance, a default value may comprise some standardized value, such as the value “0” for an integer field, the value “dummy string” for a string field, or the like. In the case of a randomized value, an algorithm may be used to generate a random string for insertion into a particular response field.

The API response need not be identically formatted as compared to API responses provided by the third-party API endpoint. While in some instances it may be advantageous to closely mirror the format and overall performance of a third-party API, there may be circumstances where the internal mock API need not perfectly replicate the format and overall process of a third-party API. For instance, an internal mock API response may comprise fewer or greater fields as compared to the third-party API responses to which it is intended to mimic. This may be used for a variety of benefits. For instance, it may be useful to include additional response fields for diagnostic purposes. As another example, it may be useful to include fewer fields when not all fields are necessary for a particular codebase.

In step 305, the computing device may transmit the API response. The API response may be transmitted over a network and back to the device to which a corresponding API request was received. For example, the computing device may transmit, via the internal endpoint and to the second computing device, the first API response.

In practice, the steps depicted in FIG. 3 may be usable to internally perform processes that would otherwise be performed by a third-party. Because internal data and services may be used, there may be instances where internal mock APIs can be used to provide better API responses as compared to the use of third-party APIs reliant on third-party services. For example, the internal data may correspond to an authentication service, and the first API response may indicate an authentication result premised on more accurate, more private/sensitive, or generally more useful authentication data. As another example, the third-party service may be a relatively acceptably-performing object recognition service, but better computing abilities may permit internal processes to perform better object recognition as compared to the third-party service. As yet another example, the internal processes may be similar to those provided by the third-party service but may be configured to account for more edge cases and unique scenarios unique to a codebase as compared to the third-party service.

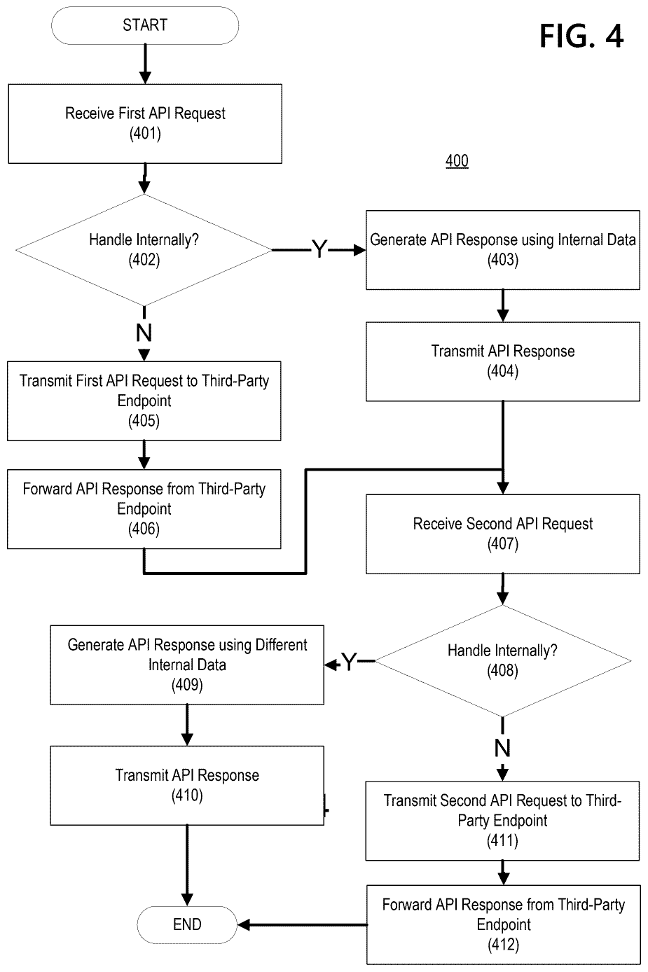

FIG. 4 depicts a method 400 comprising steps for selectively servicing API requests using internal data or routing API requests to a third-party API endpoint which may be performed by a computing device, such as any one of the devices described with respect to FIG. 1 and/or FIG. 2. The steps shown in FIG. 4 are illustrative, and may be re-arranged, omitted, and/or modified as desired. A computing device may comprise one or more processors and memory storing instructions that, when executed by the one or more processors, cause the performance of one or more of the steps depicted in FIG. 4. One or more non-transitory computer-readable media may store instructions that, when executed, cause the performance of one or more of the steps depicted in FIG. 4.

In step 401, a computing device may receive a first API request. This step may be the same or similar as the process described with respect to step 303 of FIG. 3. For example, the computing device may receive, from a second computing device, a first API request to a mock first API provided by an internal endpoint. That mock first API may correspond to a first API provided by the third-party API endpoint and may be configured to service at least a portion of calls using internal data and route at least a portion of calls to the first API. Moreover, the mock first API may be configured to service API requests corresponding to the first API using internal data

In step 402, the computing device may determine whether to handle the first API request internally. This decision may be based on a variety of criteria, as there may be a variety of reasons why an API request might be handled internally (e.g., by internal data and/or services) or externally (e.g., forwarded to a third-party API endpoint for handling by a third-party API service). In turn, the computing device may determine whether to handle the first API call using internal data based on criteria specifying whether to handle first API calls via the internal endpoint or the third-party API endpoint. That criteria may relate to, for instance, whether the code providing the API request is in a production or development status, the ability of the internal processes to service (e.g., adequately respond to) the API request, the uptime and general availability of a third-party API endpoint, and the like. If it is decided to handle the API response internally, the method 400 proceeds to step 403. Otherwise, the method 400 proceeds to step 405.

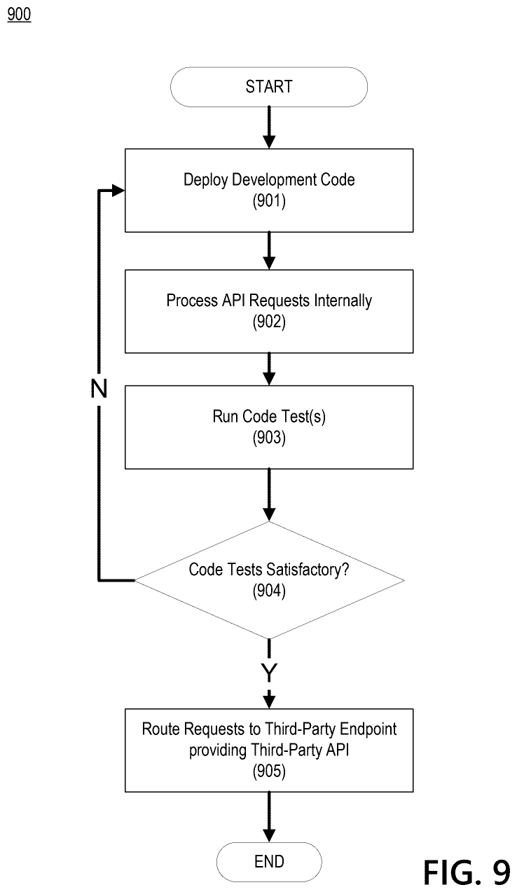

As part of determining whether to handle the first API request internally, the computing device may evaluate the development status of code. For example, the computing device may determine whether to handle the first API request via the internal endpoint or the third-party API endpoint based on whether code executing on the second computing device is in a development status. In this manner, development code API calls might be kept internal to avoid unnecessary cost, sending malformed data to a third party, or the like. Additionally and/or alternatively, this process may be based on the result of code tests. For example, the computing device may receive a result of one or more code tests and may determine whether to handle the first API request using internal data based on the result. An example of how such code tests might affect the handling of API requests is discussed below with respect to FIG. 9.

As part of determining whether to handle the first API request internally, the computing device may evaluate whether the internal data can be used to generate a response to the API request. Not all API requests might be able to be addressed internally. For example, an API request may ask for data unavailable internally, and/or the processes required to generate an API response to a particular API request may require access to forms of data that are unavailable internally. In turn, if an API request cannot be handled internally, then the API request might be sent to a third-party endpoint for handling via a third-party service. In contrast, if the API request can be handled internally, then it might be preferable in some circumstances (e.g., for data security reasons, for speed reasons) to handle it internally instead.

In step 403, the computing device may generate an API response using internal data. This process may be the same or similar as step 304 of FIG. 3. This may comprise using all or portions of the received API request to determine data (e.g., from the one or more internal databases 206) to include in a response. For example, the computing device may generate, based on the first API request, a first API response that comprises one or more first response fields specified by a third-party API specification for the first API.

In step 404, the computing device may transmit the generated API response. This step may be the same or similar as step 305 of FIG. 3. For example, the computing device may transmit, to the second computing device and in response to the first API request, the first API response.

In step 405, the computing device may transmit the first API request to the third-party endpoint. For example, the computing device may, based on determining to not handle the first API call using the internal data, route the second API request to a third-party API endpoint.

In step 406, the computing device may forward an API response received from the third-party endpoint. For example, the computing device may receive, from the third-party API endpoint, a second API response, generate a response based on the second API response received from the third-party API endpoint, and send, to the second computing device, the response generated based on the second API response.

Step 407 through step 412 illustrate how different API requests might be handled differently based upon, among other things, the internal mock API to which they are directed, the properties of (including data within) API requests, and the like. Indeed, as will be described below, two different API requests sent to an internal endpoint and in compliance with an internal mock API need not always be handled identically, particularly where (for example) internal processes are sufficient to service one request but not the other. For example, the computing device may receive, from the second computing device, a third API request and then, based on the criteria, process the third API request using the internal endpoint by generating, using the internal endpoint and based on the third API request, a third API response using a different process compared to the generation of the first API response and transmitting, to the second computing device and in response to the first API request, the first API response.

In step 407, the computing device may receive a second API request, which may be the same or similar as step 303 of FIG. 3 or step 401 of FIG. 4. That said, the second API request may be different from the first API request of step 401 in some way: it may be intended for a different API, may be for a similar API but comprise different data in one or more request fields, or the like.

In step 408, the computing device may determine whether to handle the second API request internally. This decision need not be the same as the decision made in step 402, even if the second API request is intended for the same internal mock API as the first API request, and even if the data is the same or substantially similar within the two requests. While the same or similar criteria may be applied, a variety of considerations may cause similar API requests to be routed differently at different times. For instance, a certain percentage of requests may be routed to a third-party endpoint, whereas the remaining percentage might be handled internally. As another example, an unexpected unavailability of a third-party endpoint may cause all received API requests to be handled internally until the third-party endpoint becomes available again. As yet another example, cost limitations may restrict a quantity of API requests to be sent to a third-party endpoint. In any event, if it is decided to internally handle the second API request, the method 400 proceeds to step 409. Otherwise, the method 400 proceeds to step 411.

In the case where the second API request is to be handled internally, steps similar to step 403 and step 404 may be performed. For instance, in step 409, the computing device may generate an API response using different internal data, and in step 410, the computing device may transmit the generated API response.

In the case where the second API request is to not be handled internally, steps similar to step 405 and step 406 may be performed. For instance, in step 411, the computing device may transmit the second API request to a third-party endpoint. Then, in step 412, the computing device may forward an API response received from the third-party API endpoint.

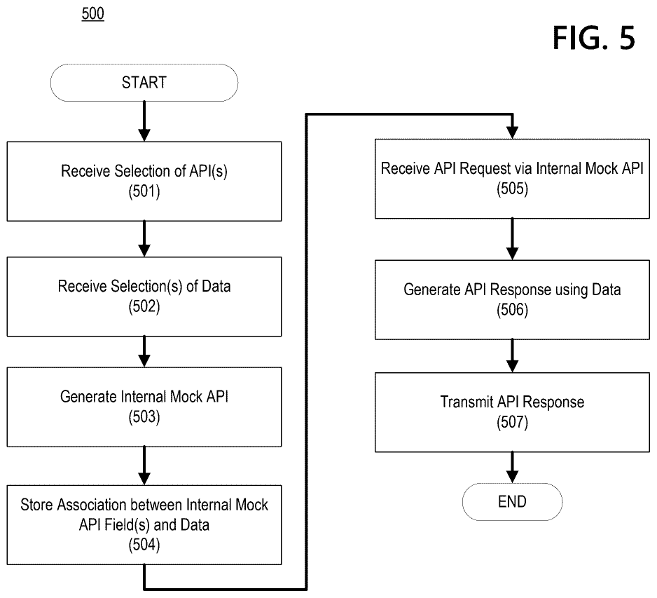

FIG. 5 depicts a method 500 comprising steps for automatically provisioning data to support one or more internal mock APIs corresponding to one or more of a plurality of APIs provided by a third-party API endpoint which may be performed by a computing device, such as any one of the devices described with respect to FIG. 1 and/or FIG. 2. The steps shown in FIG. 5 are illustrative, and may be re-arranged, omitted, and/or modified as desired. A computing device may comprise one or more processors and memory storing instructions that, when executed by the one or more processors, cause the performance of one or more of the steps depicted in FIG. 5. One or more non-transitory computer-readable media may store instructions that, when executed, cause the performance of one or more of the steps depicted in FIG. 5.

In step 501, a computing device may receive a selection of one or more APIs. This process may involve providing a user interface to a user that permits the user to identify, from a variety of APIs provided by a third-party API endpoint, one or more APIs to be mirrored internally, and then receiving some form of input via that user interface. For example, the computing device may receive an indication of a selection of a first API of the plurality of APIs provided by the third-party API endpoint.

In step 502, the computing device may receive one or more selections of data. This process may involve providing a user interface (the same or different as compared to step 501) to a user that permits the user to identify, from various databases such as the one or more internal database 206, data elements to be used as part of servicing one or more of the APIs selected in step 501, then receiving some form of input via that user interface. For example, the computing device may receive a selection of one or more sets of data, from one or more databases, to be used in responding to calls corresponding to the selected first API.

The selections of data might be specific to unique portions of the data, such as particular data elements, columns, rows, or the like, for use in all or portions of an API request. This process might comprise, for example, a user indicating subsets of data to be used in a particular portion of an API response. For example, the selection of the one or more sets of data may comprise an identification of at least one row, column, and/or table stored by the one or more databases and/or an identification of at least one response field of the first response fields. As another example, the selection might indicate one or more rules for how data should be used in an API response. For example, the selection of the one or more sets of data may comprise an identification of one or more rules for using the one or more sets of data in at least one response field of the first response fields. Such rules may indicate, for example, a format of the data (e.g., that a float is to be converted to an integer), a length of the data (e.g., a maximum amount of the data to use, a quantity of a particular set of text content to use), or the like. Such rules may be conditional. For example, some rules may specify that one column of a table is to be used in response to API requests of a first type, whereas another column of the same table is to be used in response to API requests of a different type. One of the many advantages of this process is that it allows a user developing the mock API to have direct control over the behavior of the mock API, even down to the particular aspects of data used in API responses in different contexts.

The selections of data need not be for every field in an API request generated by an internal mock API. For example, a user might specify that some fields are to contain real data, whereas others are to be filled with automatically-generated data, a default value, or the like. For example, the user might specify that real first names are to be used, but that last names and addresses are to be generated randomly to preserve privacy. As another example, a user might specify that a certain unused field of an API response is always filled with a “null” value or a similar value. In turn, API responses generated via an internal mock API might contain such automatically-generated and/or default values.

In step 503, the computing device may generate an internal mock API. This process may be the same or similar as step 302 of FIG. 3. For example, the computing device may generate a mock first API corresponding to the first API, wherein the mock first API is provided by an internal endpoint and is generated based on formats of first request fields and formats of first response fields specified by a third-party API specification for the first API, and wherein the mock first API is configured to service API requests corresponding to the first API using the one or more sets of data.

As part of generating the internal mock API, the computing device may replicate (e.g., cache) the data selected in step 502. For example, the computing device may cache at least a portion of the one or more sets of data. This process may be performed so as to avoid generating queries directed to specific live databases, particularly in the context of code development where malformed queries could introduce risk to the data stored by those live databases. This process may additionally and/or alternatively be performed so as to increase speed during development, especially in circumstances where the data selected as part of step 502 is not easily accessible by the computing device (e.g., the data is stored on a remote server). In turn, the caching may be conditioned on a location of the data (e.g., whether it can be retrieved successfully), whether the internal mock API is for code development purposes (suggesting that caching is preferable to providing access to a production database), a size of the data (e.g., whether caching is possible given the size of the data set), a security level of the data (e.g., whether the data involves personal information), or the like.

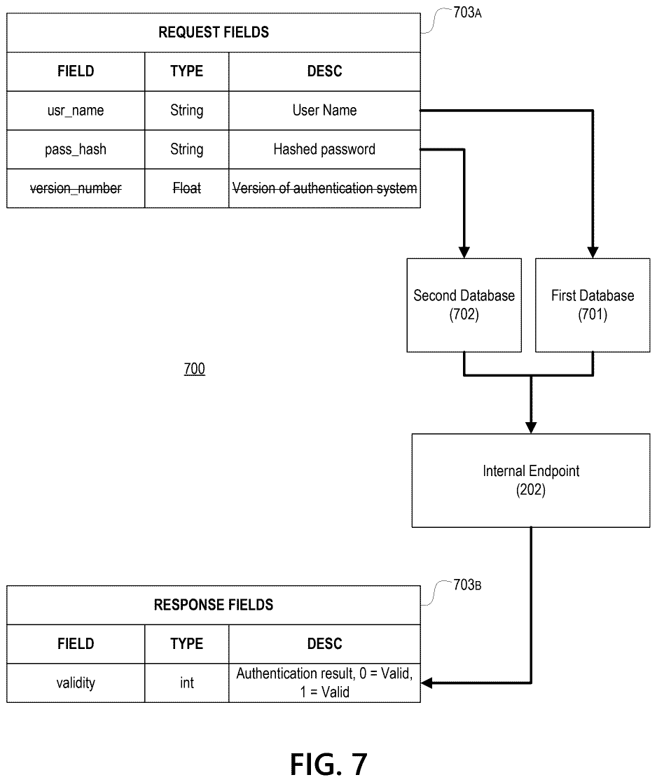

In step 504, the computing device may store an association between fields of the internal mock API and the selected data. An association of this type may indicate, for instance, which of the selected elements of data are meant to be used in servicing an internal mock API. For example, the computing device may store an association between at least one field of the first request fields and the first response fields and/or at least one data element of the one or more sets of data from the one or more databases. In this manner, the associations may be usable to service API requests by locating, as needed, internal data (e.g., via the one or more internal databases 206) that can be used as part of formulating an API response. An example of such associations is described below with respect to FIG. 7.

As an example of step 504, assume that the internal mock API relates to a user authentication process, where an API request indicates authentication credentials and where the API response indicates whether the credentials are valid. Such a process implies that, as part of generating the API response, the authentication credentials are validated, such as being compared to a database of authentication credentials. In turn, the association stored as part of step 504 may indicate the location of such authentication credentials. For example, the associations may indicate a column of a table in one database where usernames might be found, and might indicate a different column of the table where corresponding password hashes might be found.

As part of storing the association between the fields and the selected data, the computing device may additionally and/or alternatively determine processing procedures for the internal mock API. The mere existence of an internal mock API does not, by itself, indicate how data is to be processed. Returning to the authentication example above, and by way of example, the existence of username and password fields in an API request format defined by a third-party API specification does not indicate how those username and password fields are to be processed and validated. In turn, as part of step 504, the computing device may define one or more processing procedures for handling API requests. For example, if usernames provided by the API request are provided in a manner that uses spaces, and if an internal database uses underscores instead of spaces, then one of the processing procedures may indicate that spaces in the username field should be programmatically replaced with underlines before the username is checked against an internal database.

Associations might be updated based on changes to third-party API specifications. Various changes to real-world APIs might implicate required changes in mock APIs. In turn, mock APIs might be updated to use different data (e.g., new portions of data, default values, randomly-generated values) based on changes to real-world APIs so as to better emulate those APIs. For example, the computing device may receive an indication of a change to the third-party API specification and modify, based on the change, the mock first API to service API requests corresponding to the first API using one or more second sets of data different from the one or more sets of data.

In step 505, the computing device may receive an API request via the internal mock API. This process may be the same or similar as step 303 of FIG. 3. For example, the computing device may receive a first API request to the mock first API provided by the internal endpoint.

In step 506, the computing device may generate an API response using the selected data. This process may be the same or similar as step 304 of FIG. 3. For example, the computing device may generate, based on the association, based on the first API request, and using the internal endpoint, a first API response. That first API response may comprise, in at least one response field of the first response fields, at least a portion of the at least one data element. Additionally and/or alternatively, the first API response may comprise, in at least one second response field of the first response fields, a default and/or automatically-generated value for the at least one second response field.

The API response may be conditioned on a nature of the API request. The API request might be generated using the internal mock API based on a status of code that sent the request. For instance, the computing device may determine whether to handle the first API call using the mock first API based on whether code executing on a second computing device is in a development status. In this way, mock APIs might be used for the purposes of development code, whereas requests might be routed to real APIs for deployed code. As another example, the request may be generated using the internal mock API based on whether the internal mock API is sufficiently capable of responding to the request with accurate data. For example, if the selected data is only capable of being used to generate simple mock API responses, then API requests necessitating relatively complex API responses might be routed to the real API. In this way, the internal mock API might be configured to perform as accurately as it can based on the data provided to it (and/or that it caches), but might hand off more complex requests to a real API.

In step 507, the computing device may transmit the API response. This step may be the same or similar as step 305 of FIG. 3.

FIG. 6 illustrates an API specification 600 including a variety of data elements. The API specification 600 is depicted in a substantially tabular format in FIG. 6 for the sake of simplicity; however, the API specification 600 may be any form of data (e.g., Extensible Markup Language (XML) structure, comma-separated values, etc.). Similarly, although the API specification 600 depicts two APIs for the sake of simplicity, an API specification 600 may indicate any number (one, multiple) of different APIs, each indicating (for example) different request/response fields.

The API specification 600 comprises a metadata section 601 comprising a version number 602, an information box 603, a server indicator 604, and an API listing 605. The version number 602 may comprise an indication of a version of the API specification 600 itself, such as a version of the OpenAPI standard to which the API specification 600 is compliant. The information box 603 comprises a description of the APIs provided by the API specification 600. The server indicator 604 comprises an indication of servers that may be addressed for the API itself, such as a Uniform Resource Locator (URL) associated with the endpoint that provides the API specification 600. The API listing 605 indicates APIs detailed by the API specification 600: here, there are two (“API_auth” and “API_encrypt”).

The API specification 600 includes request and response fields for a first API 606, which for the purposes of illustration involves authentication. Those request fields include a user name field 607, a password hash field 608, and a version number field 609. These fields are all examples of fields that might be provided in an API request in accordance with the first API 606. The response fields for the first API 606 include a validity field 610. The validity field 610 is one example of a field that might be provided as part of an API response in accordance with the first API 606 defined by the API specification 600. For example, in response to an API request comprising a user name, password, and version number (as included in the user name field 607, the password hash field 608, and/or the version number field 609), an authentication process may be performed, and the computing device may respond with an API request including a “0” or “1” (as included in the validity field 610) to indicate whether the authentication process was successful.

The API specification 600 also includes request and response fields for a second API 611, which for the purposes of illustration involves string encryption. Those request fields include a string field 612. This type of field might be provided in an API request in accordance with the second API 611. The response fields for the second API 611 include an encrypted string field 613. The encrypted string field 613 is one example of a field that might be provided as part of an API response in accordance with the second API 611 defined by the API specification 600. For example, in response to an API request comprising a string (e.g., in the string field 612), an encrypted

FIG. 7 shows associations 700 between request fields 703a, internal databases such as the first database 701 and the second database 702, and response fields 703b. As shown in FIG. 7, two fields from the request fields 703a might be associated with different databases: for example, a user name field might be associated with a first database 701, whereas a password hash field might be associated with a second database 702. In practice, this may indicate that validation of the user name field might be based on data (e.g., a list of usernames) stored by the first database 701, whereas validation of the password hash field might be based on data (e.g., a list of hashed passwords) stored by the second database 702. Such information (e.g., whether appropriate matches were found) might be sent to the internal endpoint 202, which might use the data to generate an API response, including the response fields 703b, that indicates a validation result.

FIG. 8 compares third-party API request fields 801 and internal mock API request fields 802. For the purposes of the example, these fields relate to an object recognition system that provides an API for image upload that responds to such upload with an identification of objects in the images. As shown in this comparison, both sets of request fields include a common field, “img,” which corresponds to an image field. A user might use such a field to upload an image. That said, the remaining fields are different. While both the third-party API request fields 801 and the internal mock API request fields 802 comprise an “objects” field, the third-party API request fields 801 use a string array to list objects believed to be in the image, whereas the internal mock API request fields 802 use an integer array that indicates unique integer identifiers of objects in a database. In this manner, while both fields might be used in a similar manner, they need not correspond identically. Moreover, while the third-party API request fields 801 indicate additional fields (size, width, height) for consideration, such fields are omitted in the internal mock API request fields 802. This may be for a variety of reasons: for example, the internal processes used to process an image might be able to easily detect its size/width/height, making those fields unnecessary. In any event, such a distinction underscores the idea that an internal mock API might be based on a third-party API, but need not be identical.

FIG. 9 depicts a method 900 comprising steps for selectively processing API requests based on the status of code tests, which may be performed by a computing device, such as any one of the devices described with respect to FIG. 1 and/or FIG. 2. The steps shown in FIG. 9 are illustrative, and may be re-arranged, omitted, and/or modified as desired. A computing device may comprise one or more processors and memory storing instructions that, when executed by the one or more processors, cause the performance of one or more of the steps depicted in FIG. 9. One or more non-transitory computer-readable media may store instructions that, when executed, cause the performance of one or more of the steps depicted in FIG. 9.

In step 901, development code may be deployed. As part of such deployment, the development code may be executed, modified, and otherwise used as desired. For example, the development code may be executed in a development environment on one or more computing devices.

In step 902, and while the development code is in a development status, API requests may be processed internally. For example, with respect to the method 400 of FIG. 4, when presented with a question as to whether to handle an API request internally, the method 400 might default to yes while the development code is in a development status. In turn, such processing may be similar to step 403, step 404, step 409, and/or step 410 of FIG. 4. This approach may be taken for a variety of reasons: it may allow developers to freely experiment with code without burdening a third-party API service, it may avoid incurring costs associated with the third-party API service during development, it may avoid sending malformed data to a third-party API endpoint during testing, and the like.

In step 903, one or more code tests may be run. Such code tests may comprise any subjective or objective evaluation of the performance of the development code, such as checking it for security issues, errors (e.g., compilation errors or otherwise), and the like. A variety of different code tests may be defined and run, whether programmatically (e.g., as part of a programmatic check of code) and/or manually (e.g., as manually established by a developer). One or more of the code tests may be associated with a score. For instance, passing one code test might add a value of five to a score, whereas passing a different code test might add a value of fifteen to the score.

In step 904, it may be determined whether the one or more code tests satisfy a threshold. Such a threshold might be defined based on the scores mentioned above: for example, a score of one hundred might be required, and each of the code tests might provide some quantity of points. If the one or more code tests do not satisfy the threshold, then the method 900 may loop back to step 901, and API requests from the development code may be processed internally. That said, if the one or more code tests satisfy the threshold, then the method 900 may proceed to step 905.

In step 905, an internal endpoint may route API requests from the code to a third-party endpoint. This process may be the same or similar as step 405, step 406, step 411, and/or step 412 of FIG. 4.

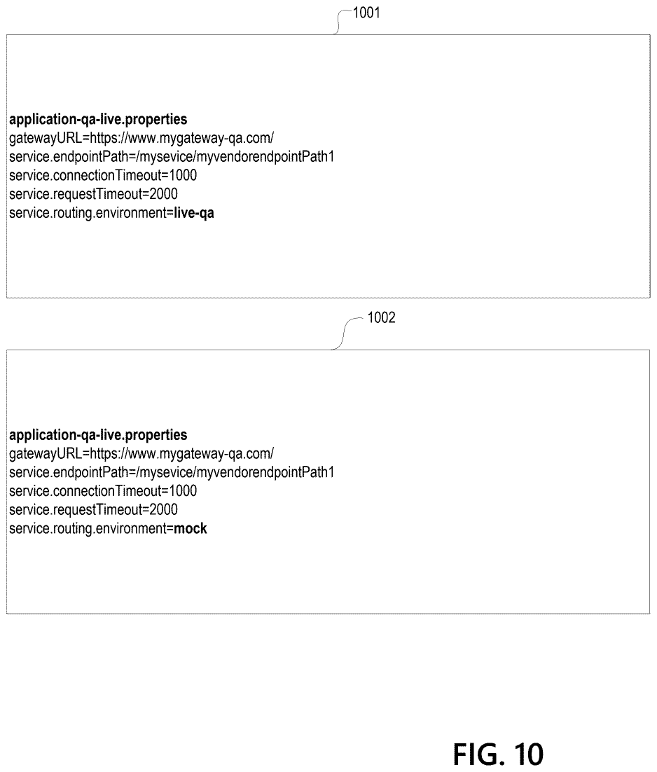

FIG. 10 depicts how code might be configured to selectively use either an internal mock API or a third-party API. As shown in FIG. 10, code 1001 indicates that API requests should be routed to “live-qa,” whereas code 1002 indicates that API requests should be routed to “mock.” In this circumstance, the code itself may instruct the internal endpoint 202 how a particular API request should be routed. Such an indication might be particularly dispositive during evaluation of criteria in, for example, step 402 and/or step 408 of FIG. 4.

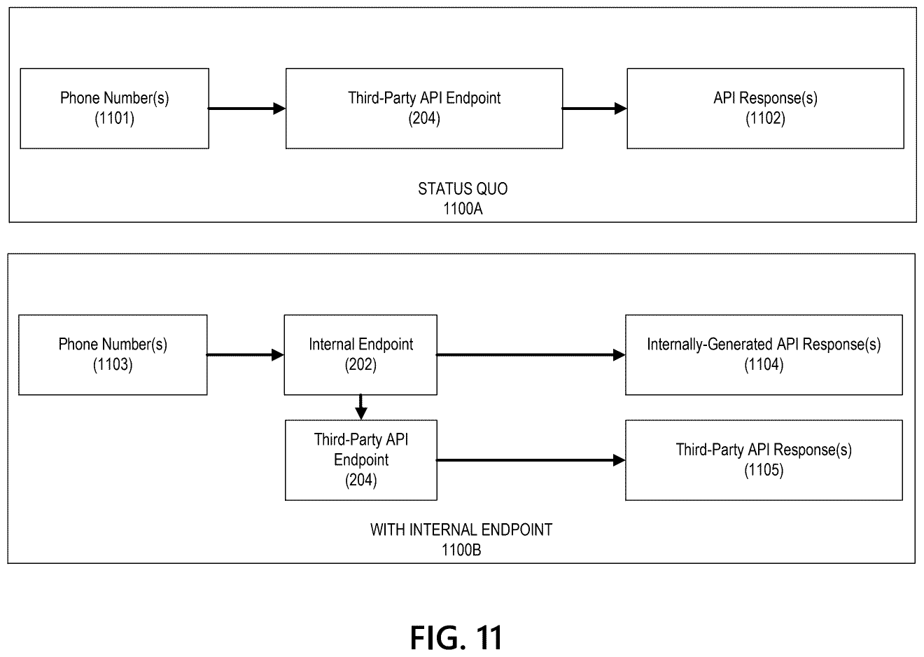

FIG. 11 compares how a phone number validation API might be performed both before and after the benefits of the present invention. In the status quo 1100A, one or more phone numbers 1101 are transmitted to the third-party API endpoint via an API, which then generates one or more API responses 1102. In contrast, in the circumstance where the internal endpoint 202 is used, one or more phone numbers 1103 are sent to the internal endpoint 202, which selectively either handles the API responses internally (generating the one or more internally-generated API responses 1104) or forwards the API responses to the third-party endpoint 204 (causing generation of the one or more third-party API responses 1105).

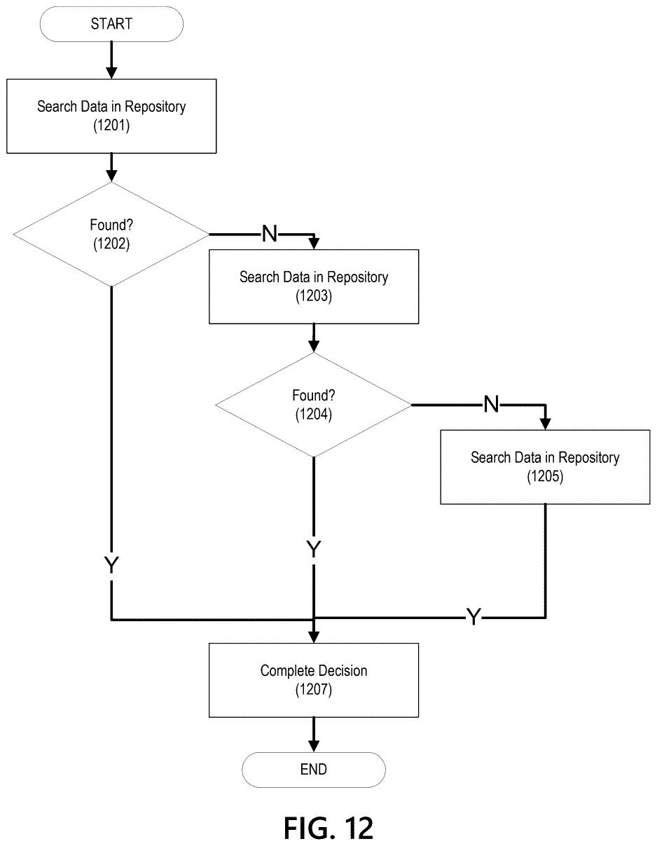

FIG. 12 depicts an example of how an internal mock API might be serviced using a series of processing procedures defined by a user. As shown in FIG. 12, a variety of decisions might exist, each defining how an ultimate complete decision is confirmed. For instance, a computing device might search the repository first in step 1201, and then decide whether matching data was found as part of step 1202. If such data is found, then a complete decision might be made in step 1207, and an API response might be generated accordingly. That said, if data is not found, the method might proceed to step 1203, where a further search might be conducted. In step 1204, the computing device might determine whether additional data is located: if so, the method may proceed to step 1207. Otherwise, a further search may be configured as part of step 1205. In this manner, users might configure a variety of rules for how data is to be used to respond to an API request using a mock API, including providing for conditional rules that indicate relative priorities of data to be used in various fields. More broadly, a variety of such flowcharts might be provided to a user (e.g., in a user interface) to allow the user to customize the performance of an internal mock API.

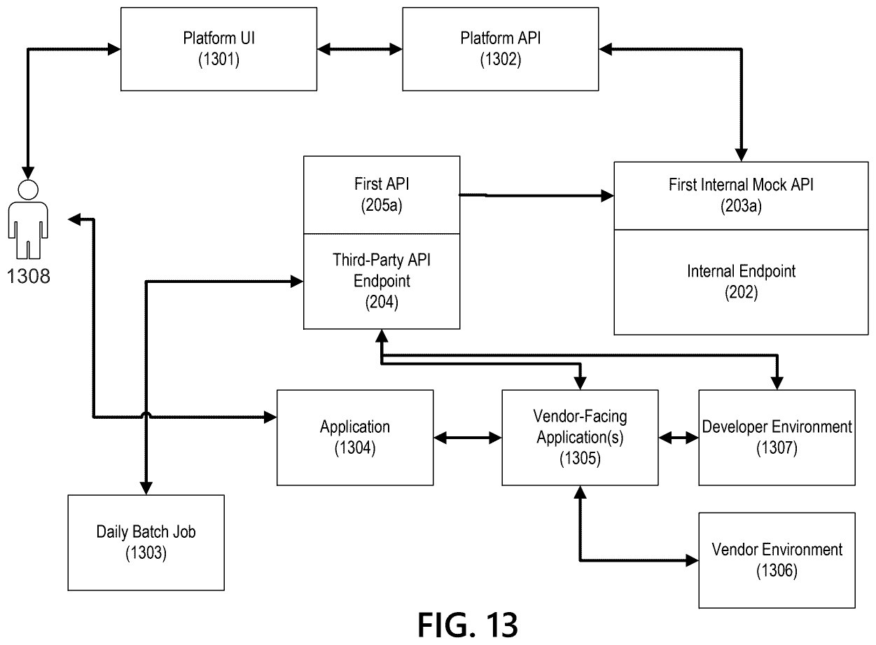

FIG. 13 depicts a system involving a user 1308, a vendor environment 1306, and a developer environment 1307 with respect to the third-party endpoint 204 and the internal endpoint 202. Broadly, the user 1308 may use a platform user interface 1031 to, via a platform API 1302, interface with internal mock APIs (such as the internal mock API 203a) provided by the internal endpoint 202. As indicated previously, that first internal mock API 203a may have been generated based on the first API 205a provided by the third-party API endpoint 204. The third-party API endpoint 204 may be periodically checked via a daily batch job 1303 which may, among other things, check a third-party API specification to confirm that internal mock APIs correspond to the APIs provided by the third-party API endpoint 204. Moreover, the third-party endpoint 204 might be controlled by vendor-facing applications 1305, the developer environment 1307, and/or the vendor environment 1306. In many cases, the vendor-facing applications 1305 may be controlled by the same organization as the internal endpoint 202, but the developer environment 1307 and/or the vendor environment 1306 may be outside of the control of that organization.

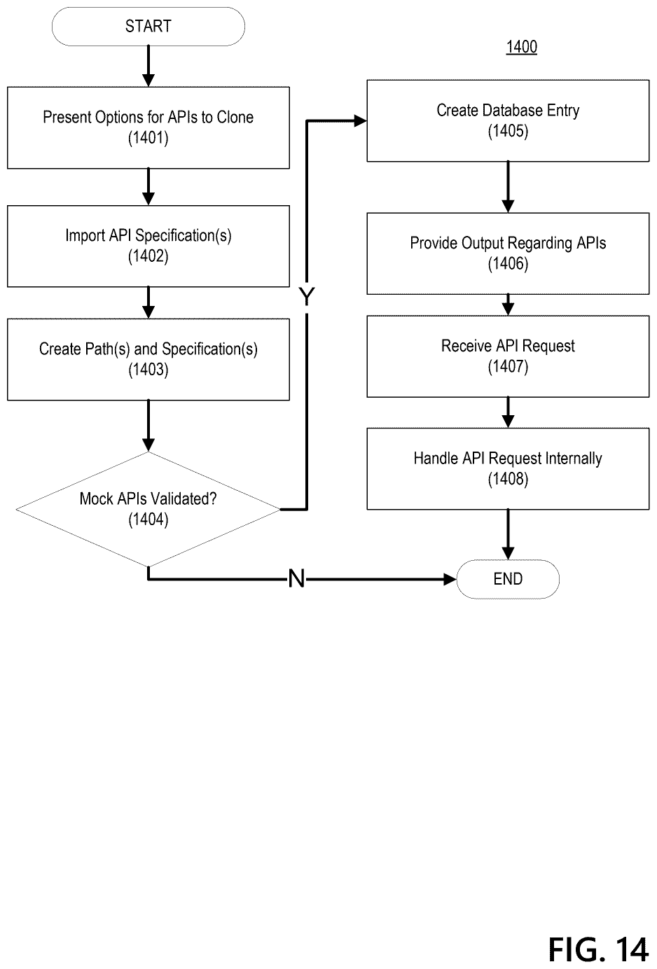

FIG. 14 is an illustrative flow chart 1400 comprising steps for receiving user instructions for creating internal mock APIs which may be performed by a computing device, such as any one of the devices described with respect to FIG. 1 and/or FIG. 2. The steps shown in FIG. 14 are illustrative, and may be re-arranged, omitted, and/or modified as desired. A computing device may comprise one or more processors and memory storing instructions that, when executed by the one or more processors, cause the performance of one or more of the steps depicted in FIG. 14. One or more non-transitory computer-readable media may store instructions that, when executed, cause the performance of one or more of the steps depicted in FIG. 14.

In step 1401, a computing device may present one or more options of APIs to mock. This step may comprise causing display of a user interface (e.g., in an application, on a website) that provides a listing of one or more APIs. For example, the user interface may list a variety of APIs available via one or more different third-party API endpoints, with the list based on third-party API specifications retrieved before display of the user interface. The user interface may additionally and/or alternatively comprise a search interface that permits searching for a particular API and/or that permits searching for third-party API specifications on one or more servers. Such a list of APIs might be based on data stored in a database, such as a database storing a list of APIs (whether third-party APIs and/or internal mock APIs). This step may be the same or similar as step 501 of FIG. 5.

In step 1402, the computing device may import one or more API specifications corresponding to one or more selected APIs to mock. This may comprise identifying the data necessary to generate mock internal APIs based on the one or more selected APIs. For instance, a user might select two different APIs as part of step 1401, and then step 1402 may comprise retrieving one or more third-party API specifications which detail the two different APIs. This process may additionally and/or alternatively comprise retrieving a URL path corresponding to the selected APIs. Returning to the example above regarding the two different APIs, this may comprise identifying the URLs used by the two different APIs, which may be usable to (for example) identify when an API request is intended for a particular API.

In step 1403, the computing device may create one or more paths and one or more mock API specifications. This process may comprise all or portions of step 503, which involves generating an internal mock API.

In step 1404, the computing device may determine whether the mock APIs have been validated. Mock internal APIs may be validated to ensure that they correctly correspond to the third-party APIs to which they correspond. A wide variety of tests may be performed to ensure that an internal mock API is performing properly. For example, this process may comprise testing one or more internal mock APIs using simulated requests and/or past requests to ensure that the requests are handled properly (e.g., an expected API response is received). As another example, this process may comprise identifying whether API requests are properly routed to the internal mock API (e.g., by comparing a response received to an expected API response from the internal mock API).

In step 1405, the computing device may create a database entry. The database entry may comprise an association between an internal mock API (e.g., fields of the internal mock API) and data, such as is described in step 504 of FIG. 5. The database entry may comprise information about the internal mock API, such as storing an internal mock API specification. This database may be the same or similar as the database used to populate the list of APIs in step 1401.

In step 1406, the computing device may provide output regarding the mock internal APIs generated. This output may comprise information such as a list of internal mock APIs, URLs corresponding to the internal mock APIs, an identification of the third-party APIs to which the internal mock APIs correspond, or the like.

In step 1407, the computing device may receive an API request. Such a request might have been via one or more of the URLs referenced above. This step may be the same or similar as step 505 of FIG. 5.

In step 1408, the computing device may handle the received API request internally. This step may be the same or similar as step 506 and step 507 of FIG. 5.

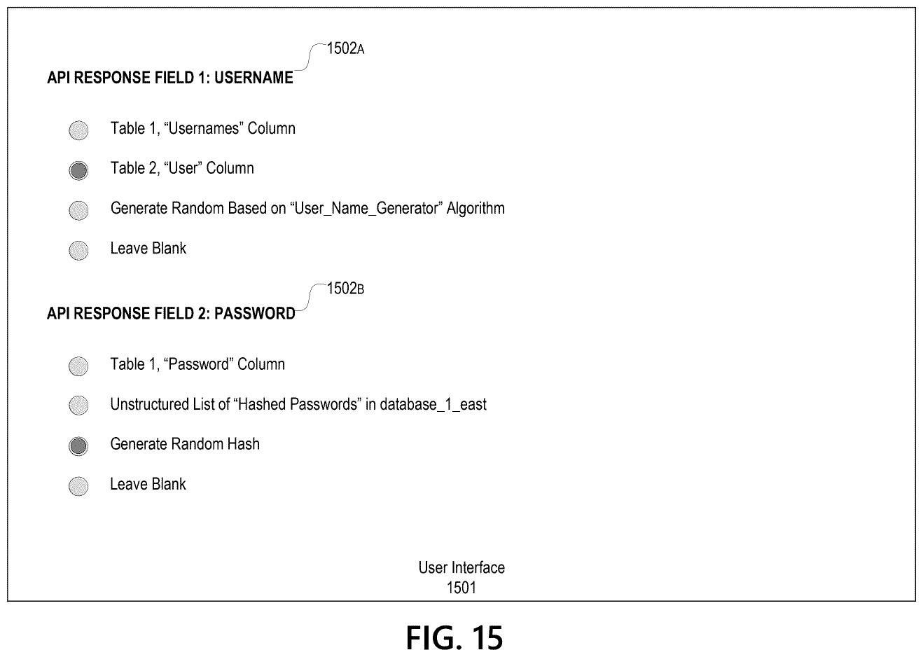

FIG. 15 depicts an illustrative user interface 1501 showing portions of a user interface that might be used by a user to select data for an API response generated by a mock API. A first user interface section 1502a prompts a user to select from various options for data to include in a mock API response username field, including particular data (from one of two different tables), to generate the data randomly based on a fake user name generation algorithm, and/or to leave the field blank. A second user interface selection 1502b prompts the user to select from various options for data to include in a mock API response password field, including particular data (from either a table or unstructured list), to generate the data randomly by inserting a randomized hash, and/or to leave the field blank. The user interface 1501 is merely illustrative, as it broadly shows how users might be in control of how a mock API responds to API requests. Other options that might be presented to a user in such a user interface may include options on priorities of data to use for a particular field (such as is depicted in FIG. 12), options to select one of a variety of algorithms to use to generate random data, options to obfuscate all or portions of real data using, for example, hash functions and/or obfuscation functions, and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to automatically generate internal mock Application Programming Interfaces (APIs) corresponding to a plurality of APIs provided by a third-party API endpoint, the computing device comprising:
one or more processors; and
memory storing instructions that, when executed by the one or more processors, cause the computing device to:
retrieve a third-party API specification that indicates supported request fields and supported response fields for each of a plurality of APIs provided by the third-party API endpoint, wherein the third-party API specification indicates, for a first API of the plurality of APIs:
formats of one or more first request fields; and
formats of one or more first response fields;
generate a mock first API corresponding to the first API based on the formats of the one or more first request fields and the formats of the one or more first response fields, wherein the mock first API is provided by an internal endpoint and is configured to service API requests corresponding to the first API using internal data;
receive, from a second computing device, a first API request, to the mock first API, that comprises at least one field of the one or more first request fields corresponding to the first API;
generate, via the internal endpoint, using the internal data, and based on the first API request, a first API response that comprises at least one of the one or more first response fields, wherein the at least one field of the one or more first response fields comprises at least a portion of the internal data; and
transmit, via the internal endpoint and to the second computing device, the first API response.

2. The computing device of claim 1, wherein the formats of the one or more first request fields indicate, for each of a plurality of request fields, a field name and a data type.

3. The computing device of claim 1, wherein the instructions, when executed, further cause the computing device to generate the mock first API by causing the computing device to:
generate an internal API specification that indicates, for the mock first API, the at least one field of the one or more first response fields.

4. The computing device of claim 1, wherein the first API response comprises a second field of the one or more first response fields, and wherein the mock first API is configured to return a default value for the second field.

5. The computing device of claim 1, wherein the first API response comprises less than all of the fields of the one or more first response fields.

6. The computing device of claim 1, wherein the first API response comprises a second field of the one or more first response fields, and wherein the mock first API is configured to return a randomized value for the second field.

7. The computing device of claim 1, wherein the internal data corresponds to an authentication service, and wherein the first API response indicates an authentication result.

8. The computing device of claim 1, wherein the instructions, when executed, further cause the computing device to:
identify a change in the third-party API specification;
determine that the change impacts at least one field of the formats of the one or more first request fields; and
update, based on the change, the mock first API.

9. A method for automatically generating internal mock Application Programming Interfaces (APIs) corresponding to a plurality of APIs provided by a third-party API endpoint, the method comprising:
retrieving a third-party API specification that indicates supported request fields and supported response fields for each of a plurality of APIs provided by the third-party API endpoint, wherein the third-party API specification indicates, for a first API of the plurality of APIs:
formats of one or more first request fields; and
formats of one or more first response fields;
generating a mock first API corresponding to the first API based on the formats of the one or more first request fields and the formats of the one or more first response fields, wherein the mock first API is provided by an internal endpoint and is configured to service API requests corresponding to the first API using internal data;
receiving, from a computing device, a first API request, to the mock first API, that comprises at least one field of the one or more first request fields corresponding to the first API;
generating, via the internal endpoint, using the internal data, and based on the first API request, a first API response that comprises at least one of the one or more first response fields, wherein the at least one field of the one or more first response fields comprises at least a portion of the internal data; and
transmitting, via the internal endpoint and to the computing device, the first API response.

10. The method of claim 9, wherein the formats of the one or more first request fields indicate, for each of a plurality of request fields, a field name and a data type.

11. The method of claim 9, wherein generating the mock first API comprises:
generating an internal API specification that indicates, for the mock first API, the at least one field of the one or more first response fields.

12. The method of claim 9, wherein the first API response comprises a second field of the one or more first response fields, and wherein the mock first API is configured to return a default value for the second field.

13. The method of claim 9, wherein the first API response comprises less than all of the fields of the one or more first response fields.

14. The method of claim 9, wherein the first API response comprises a second field of the one or more first response fields, and wherein the mock first API is configured to return a randomized value for the second field.

15. One or more non-transitory computer readable media storing instructions configured to automatically generate internal mock Application Programming Interfaces (APIs) corresponding to a plurality of APIs provided by a third-party API endpoint, wherein the instructions, when executed by one or more processors of a computing device, cause the computing device to:
retrieve a third-party API specification that indicates supported request fields and supported response fields for each of a plurality of APIs provided by the third-party API endpoint, wherein the third-party API specification indicates, for a first API of the plurality of APIs:
formats of one or more first request fields; and
formats of one or more first response fields;
generate a mock first API corresponding to the first API based on the formats of the one or more first request fields and the formats of the one or more first response fields, wherein the mock first API is provided by an internal endpoint and is configured to service API requests corresponding to the first API using internal data;
receive, from a second computing device, a first API request, to the mock first API, that comprises at least one field of the one or more first request fields corresponding to the first API;
generate, via the internal endpoint, using the internal data, and based on the first API request, a first API response that comprises at least one of the one or more first response fields, wherein the at least one field of the one or more first response fields comprises at least a portion of the internal data; and
transmit, via the internal endpoint and to the second computing device, the first API response.

16. The one or more non-transitory computer readable media of claim 15, wherein the formats of the one or more first request fields indicate, for each of a plurality of request fields, a field name and a data type.

17. The one or more non-transitory computer readable media of claim 15, wherein the instructions, when executed, further cause the computing device to generate the mock first API by causing the computing device to:
generate an internal API specification that indicates, for the mock first API, the at least one field of the one or more first response fields.

18. The one or more non-transitory computer readable media of claim 15, wherein the first API response comprises a second field of the one or more first response fields, and wherein the mock first API is configured to return a default value for the second field.

19. The one or more non-transitory computer readable media of claim 15, wherein the first API response comprises less than all of the fields of the one or more first response fields.

20. The one or more non-transitory computer readable media of claim 15, wherein the first API response comprises a second field of the one or more first response fields, and wherein the mock first API is configured to return a randomized value for the second field.
